(19) United States
(12) Patent Application Publication
(10) Pub. No.: US 2009/0208781 A1
(43) Pub. Date: Aug. 20, 2009

(54) METHOD FOR OPERATING A FUEL CELL SYSTEM

(76) Inventors: George A. Skinner, Burnaby (CA); Anthony G. W. Cochrane, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 12/033,771

(22) Filed: Feb. 19, 2008

(51) Int. Cl. H01M 8/04

(52) U.S. Cl. 429/13

(57) ABSTRACT

A method for operating a fuel cell system comprising: a first fuel cell stack having a first current and a first temperature, electrically coupled in parallel with a second fuel cell stack having a second current and a second temperature, may include: triggering a fault response when a differential between the first and second currents or between the first and second temperatures exceeds a respective threshold.

### BACKGROUND

1. Technical Field

The present disclosure relates to a method for operating a fuel cell system having fuel cell stacks coupled in parallel where a fault is triggered in response to a current or temperature differential

2. Description of the Related Art

Fuel cells convert fuel and oxidant to electricity and reaction product. Solid polymer electrochemical fuel cells generally employ a membrane electrode assembly (“MEA”) consisting of a polymer electrolyte membrane (“PEM”) (or ion exchange membrane) disposed between two electrodes. The electrodes comprise porous, electrically conductive sheet material. An electrocatalyst is disposed at each membrane/electrode layer interface to induce the desired electrochemical reaction. The MEA is further disposed between two electrically conductive fluid flow field plates. Fluid flow field plates have at least one flow passage formed therein to direct the fuel and oxidant to the respective electrodes, namely, the anode on the fuel side and the cathode on the oxidant side. The plates also act as current collectors and provide mechanical support for the electrodes.

At the anode, fuel, typically in the form of hydrogen gas, reacts at the electrocatalyst in the presence of the PEM to form hydrogen ions and electrons. At the cathode, oxidant reacts at the electrocatalyst in the presence of the PEM to form oxygen anions. The PEM facilitates the migration of the hydrogen ions from the anode to the cathode where they react with anions formed at the cathode. The electrons pass through an external circuit, creating a flow of electricity. The net reaction product is water. The anode and cathode reactions are shown in the following equations:

H₂→2H⁺+2e⁻ (1)

½O₂+2H⁺+2e⁻→H₂O (2)

Electric potential may be increased by assembling fuel cells in series to form a fuel cell stack where one side of a given flow field plate serves as an anode plate for one fuel cell and a cathode plate for an adjacent fuel cell. Current may be increased by increasing the active area of the fuel cell or by electrically coupling fuel cell stacks in parallel.

The fuel cell stack may therefore, include inlet ports and/or manifolds for directing fuel and oxidant to the anode and cathode flow fields respectively. The fuel cell stack may also include a manifold and inlet port for directing a coolant fluid, typically water, to interior passages within the fuel cell stack to absorb heat generated by the exothermic reaction in the fuel cells. The fuel cell stack may also include exhaust manifolds and outlet ports for expelling the unreacted fuel and oxidant gases, as well as an outlet port for expelling coolant from the fuel cell stack.

Commercial fuel cell system applications may have a particular potential, current and/or power requirement. A fuel cell stack may therefore be constructed to meet such potential and/or current requirements. However, such a method may require the manufacture of specifically tuned fuel cells, stack components and systems, which can be costly. An alternate method of increasing the overall potential is to arrange multiple fuel cell stacks in a series array. Similarly, another way of increasing the overall current is to arrange multiple fuel cell stacks in a parallel array.

Commercial fuel cell system applications may also have a particular robustness requirement such as tolerance to cell reversal, a common form of fault in a fuel cell system. Cell reversal occurs when a particular fuel cell in a stack cannot generate sufficient current from the electrochemical reactions noted above to pass the current generated by the other cells in the stack. Therefore, in order to pass current generated by the other fuel cells in the fuel cell stack, reactions other than fuel oxidation may take place at the fuel cell anode, including undesirable reactions such as water electrolysis and oxidation of anode components which, may result in degradation of the fuel cell stack. Several conditions can lead to cell reversal including for example, insufficient oxidant, insufficient fuel, insufficient water, low or high cell temperatures, and certain problems with cell components or construction. Cell reversal generally occurs when one or more cells experience a more extreme level of one of these conditions compared to other cells in the stack. While each of these conditions can result in negative fuel cell voltages, the mechanisms and consequences of such cell reversal may differ depending on which condition caused the reversal. Groups of cells within a stack can also undergo voltage reversal and even entire stacks can be driven into voltage reversal by other stacks in an array. Cell reversal therefore poses reliability and safety concerns. For example, where a cell reversal continues unchecked, heat may permanently damage the MEA seal or other fuel cell stack components.

Fuel cell systems known in the art detect faults, such as cell reversal by measuring the voltage across individual fuel cells in a fuel cell stack, across groups of fuel cells in a fuel cell stack, or across entire fuel cell stacks in an array. For example, U.S. Pat. No. 6,953,630 discloses a bipolar junction transistor coupled across pairs of fuel cells in a fuel cell stack to monitor the voltage across each fuel cell. U.S. Pat. No. 6,730,423 discloses an electrical contacting device for a fuel cell assembly comprises a printed circuit board comprising electrically conductive regions for providing reliable electrical contact with fuel cell components of the fuel cell assembly. Other fuel cell systems known in the art detect faults such as cell reversal by a contacting device comprising a non-metallic, electrically conductive elastomeric composition for providing reliable, corrosion resistant electrical contacts to fuel cell components, such as that disclosed in US 20030215678. Such cell voltage monitors are expensive, prone to failure and may result resulting in spurious alarms unnecessarily shutting down the fuel cell system.

Therefore, it is desirable to have a method for monitoring fuel cell systems that is low cost, easily implemented and robust. The present disclosure addresses these and associated benefits.

### BRIEF SUMMARY

In one embodiment, a method for operating a fuel cell system is disclosed, the fuel cell system comprising: a first fuel cell stack operable to produce a first current, a second fuel cell stack operable to produce a second current electrically coupled in parallel with the first fuel cell stack, the method comprising: determining if a differential between the first current and the second current exceeds a threshold and triggering a fault response in response to the differential between the first current and the second current exceeding the threshold.

In another embodiment, a method for operating a fuel cell system is disclosed, the fuel cell system comprising: a first fuel cell stack operable to produce a first current and a second fuel cell stack operable to produce a second current, the second fuel cell stack electrically coupled in parallel with the first fuel cell stack; the method comprising: sensing the first current; determining the second current; determining a current differential between the first current and the second current and triggering a fault response when the current differential exceeds a threshold. Determining the second current may comprise sensing the second current.

In a third embodiment, a method for operating a fuel cell system is disclosed, the fuel cell system comprising: a first fuel cell stack characterized by a first temperature that may vary during operation and a second fuel cell stack characterized by a second temperature that may vary during operation; the method comprising: sensing the first temperature, sensing the second temperature and triggering a fault response when a differential between the first and second temperatures exceeds a threshold.

In some embodiments, the fault responses may comprise increasing the supply of reactant to a fuel cell stack, electrically isolating the fuel cell stack from a load, triggering an alarm, and/or alerting an operator.

In some embodiments, the threshold is based on operating conditions of the fuel cell system.

### BRIEF DESCRIPTION OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a graph of current versus current differential.

FIG. 2 is a graph of cell reversal magnitude versus current differential.

FIG. 3 is a graph of current differential versus number of cells.

FIG. 4 is a schematic diagram of a fuel cell system.

FIG. 5 is a schematic diagram of a fuel cell system.

FIG. 6 is a flow diagram illustrating at least one embodiment.

### DETAILED DESCRIPTION

The headings and Abstract of the Disclosure provided herein are for convenience only and do not interpret the scope or meaning of the embodiments.

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with fuel cells, fuel cell stacks, MEAs and/or PEMs have not been shown or described in detail to avoid unnecessarily obscuring descriptions of the embodiments.

Unless the context requires otherwise, throughout the specification and claims which follow, the word “comprise” and variations thereof, such as “comprises” and “comprising” are to be construed in an open, inclusive sense, that is as “including but not limited to”.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

As used herein, the terms ‘deep’ and ‘shallow’ are relative terms and do not refer to any particular value or scale.

Every fuel cell stack will have an operating point with a particular current for a particular voltage under a particular set of operating conditions. The relationship between stack voltage and stack current at given set of operating conditions defines a polarization curve. That is, the potential of a fuel cell stack is a function of the current it produces under a given set of operating conditions. A generic polarization curve can be described by Equation (3):

V=f(I) (3)

A theoretical curve fit for empirical polarization curves for a normal operating fuel cell stack has been described in Kim, J.; Lee, S., Srinivasan, S., Chamberlin, C. E, Modeling of Proton Exchange Membrane Fuel Cell Performance with an Empirical Equation, J. Electrochem. Soc., Vo. 142, No. 8, August 1995 2670-2674.

V=V₀−b log i−Ri−meⁿⁱ (4)

In Equation (4), Vo is the stack open circuit voltage, b is the Tafel slope (a stack kinetic loss parameter), R is the stack internal resistance and m and n are curve fit parameters for mass transport properties of the stack.

A fuel cell stack which has a fuel cell undergoing cell reversal will operate at a different potential for a given current as compared to the same stack operating without a cell reversal. That is, the polarization curve will therefore shift from its normal operating position, due to the cell reversal. An adjusted theoretical curve fit for a fuel cell stack with a fuel cell undergoing cell reversal can be described by adjusting Equation (4) to yield Equation (5):

V=V₀−Vᵣₑᵥ−b log i−Ri−meⁿⁱ (5)

where Vᵣₑᵥ is the magnitude of the cell reversal.

When multiple substantially similar fuel cell stacks are electrically coupled in parallel, the fuel cell stacks operate at identical potentials, as dictated by Kirchoff's laws. That is, as shown in Equation (6), the potential of the first fuel cell stack (V₁) is equal to that of the second fuel cell stack (V₂), which is equal to the potential of the k^{th} fuel cell stack (Vₖ)

V₁=V₂= . . . =Vₖ (3)

As such, Equations (4) and (5) can be equated, or substituted into Equation (3) to produce a relationship between a normally operating stack electrically coupled in parallel with a fuel cell stack undergoing cell reversal.

Vᵣₑᵥ+b log i_{fail}+Ri_{fail}+meⁿⁱ^{_{fail}}=b log iₙₒₘ+Riₙₒₘ+meⁿⁱ^{ₙₒₘ} (7)

where i_{fail} is the current output of the stack experiencing the cell reversal and where Iₙₒₘ is the current of the normally operating fuel cell stack.

Equation (7) can be solved using numerical methods to determine the differential between the current of the normal operating fuel cell stack and the current of a fuel cell stack undergoing cell reversal for a given Vᵣₑᵥ, the cell reversal magnitude one seeks to detect. This calculation is not affected by the number of fuel cell stacks connected in parallel.

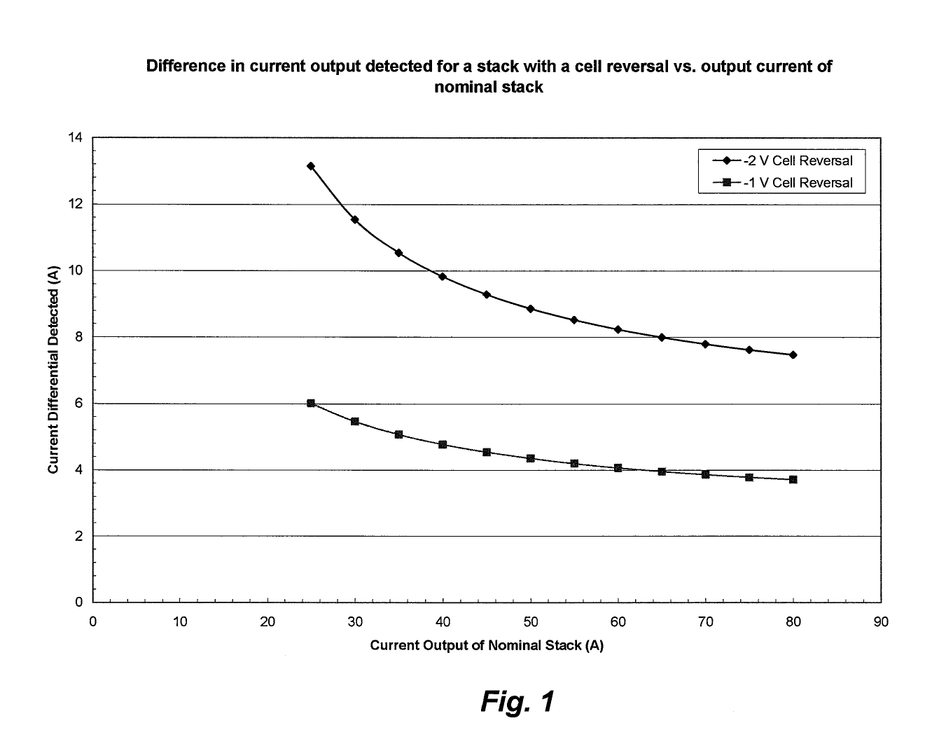

FIG. 1 shows the calculated current differential between a normal operating fuel cell stack and a fuel cell stack undergoing cell reversal plotted for 56-cell stacks. FIG. 1 shows both −1 V and −2 V cell reversal magnitudes. As can be seen from FIG. 1, as the reversal magnitude to be detected increases, current differential detection threshold decreases. FIG. 1 also shows that a −2 V cell reversal results in a greater current differential as compared to a −1 V cell reversal.

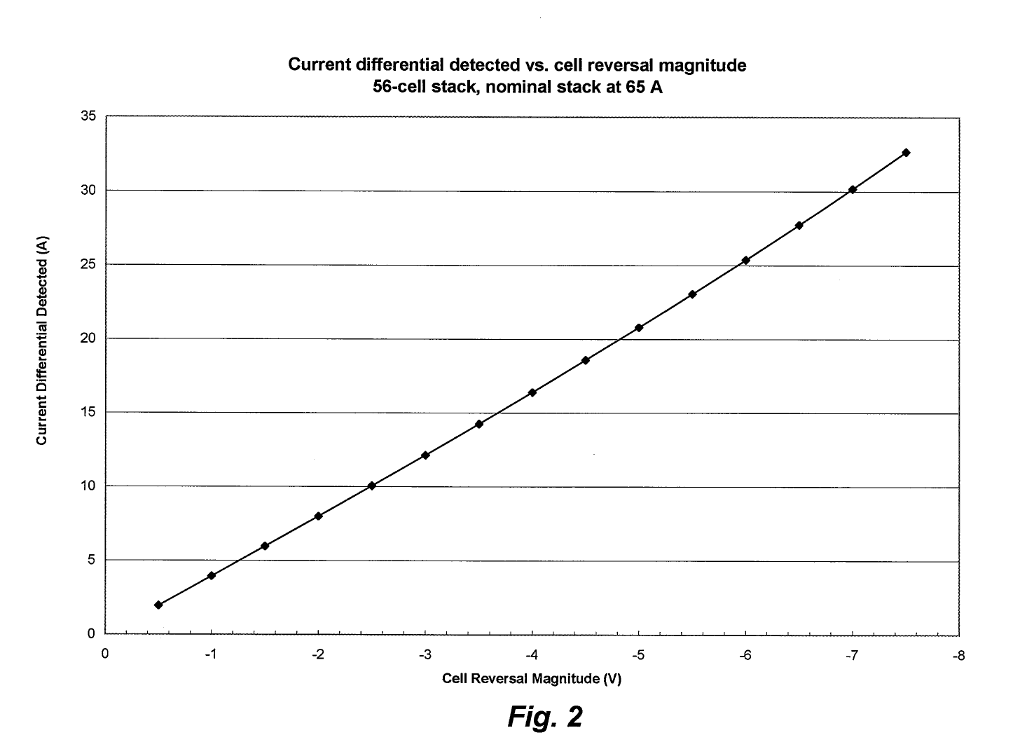

FIG. 2 shows the calculated relationship between the magnitude of the cell reversal to be detected and the current differential between nominal and failing stacks for a fixed nominal stack current of 65 A on a 56-cell fuel cell stack. Cell reversals become more problematic as reversal magnitude increases, with increasingly problematic levels typically being lower than −2 V. The critical size for a cell reversal is typically when the reversal begins to produce sufficient heat to raise cell temperature to a point where components fail thermally, or when cell breakdown voltage is exceeded (i.e., the current overcomes the resistance of the membrane in the cell and the current shorts across the cell).

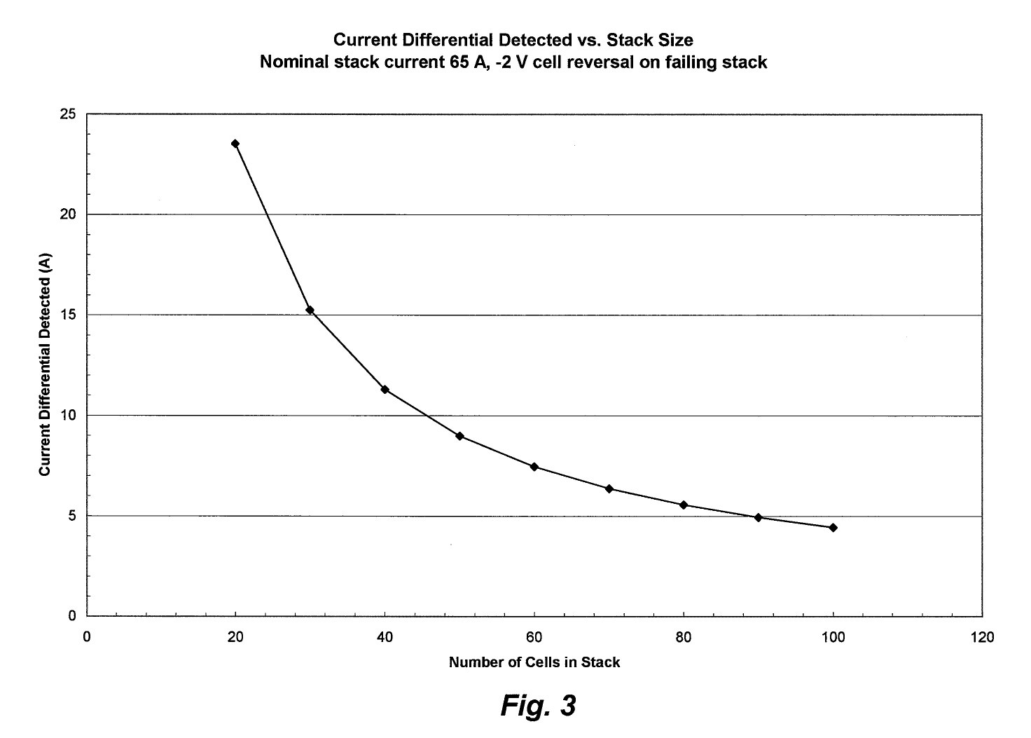

Stack voltage increases as the number of its component unit cells increases, reducing the proportional impact of a cell reversal on total stack voltage. Therefore, current differential detected for a cell reversal varies depending on the size of the stacks being used. FIG. 3 shows the variation in current differential detected between normally operating and failing fuel cell stacks with stack size, for a fixed cell reversal magnitude and normally operating fuel cell stack operating current.

Thus, it has been found that a measurement of the differential of current of fuel cell stacks electrically coupled in parallel can be indicative of cell reversal. Where one fuel cell stack enters into cell reversal, a current differential will be produced. As noted, a fuel cell stack undergoing cell reversal will produce more heat than a fuel cell stack coupled in parallel that is not undergoing cell reversal. As such, the differential between the temperature of a first fuel cell stack electrically coupled in parallel with a second, substantially similar fuel cell stack, can indicate a cell reversal. When the current (or temperature) differential is detected, a fault response may be triggered. A fault response is generally conducted to negate the effect of the fault and may include increasing reactant to the fuel cell stack or system, electrically isolating the fuel cell stack with the lower current from the load, electrically isolating the fuel cell system from the load, triggering an alarm, and alerting an operator to take the appropriate action, for example. A person of ordinary skill in the art may select an appropriate fault response for a particular application. Fault responses are disclosed further below.

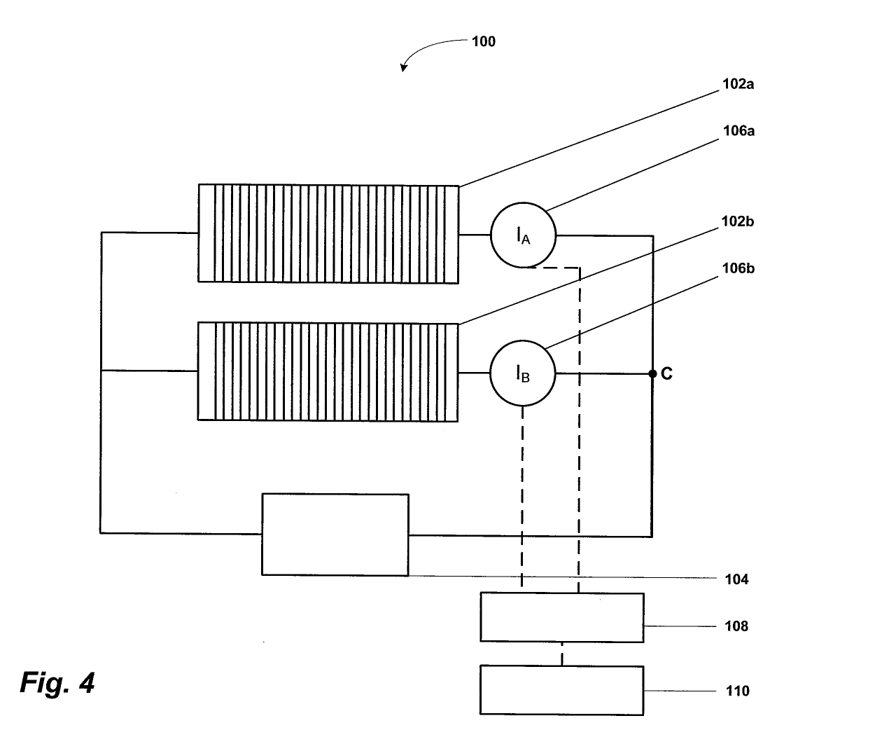

FIG. 4 shows a fuel cell system 100 wherein the method disclosed herein may be implemented. Fuel cell system 100 includes fuel cell stacks 102a, 102b electrically coupled in parallel to supply power to a load 104. Fuel cell system 100 also includes current sensor 106a adapted to sense the current in fuel cell stack 102a and current sensor 106b adapted to sense the current in fuel cell stack 102b. A current differentiator 108 is adapted to determine a current differential between the sensed currents from current sensor 106a and 106b. Current comparator 110 compares the current differential to a threshold. When current comparator 110 determines that the current differential is greater than a preset threshold (as described above), a fault response triggered. While shown in FIG. 4 as separate element, a person of ordinary skill in the art will recognize that current differentiator 108 and current comparator 110 may be a single element. Determining the current differential may be done actively, such as by a controller, or may be done passively, such as by operation of a subtracting circuit, for example. The current differential threshold may be selected for the highest operating current anticipated for the system. This will produce a conservative threshold as the current differential threshold decreases with increasing stack current. That is, at lower stack currents the alarm will be triggered well before an unsafe or undesirable condition results.

A current sensor may alternatively be located at point C in FIG. 4 to sense the third current which is the aggregation of the first and second currents where the second current could be determined by subtracting the first current, that is, the current sensed by current sensor 106a. Determining the second current may be done actively, such as by a controller, or may be done passively, such as by operation of a subtracting circuit.

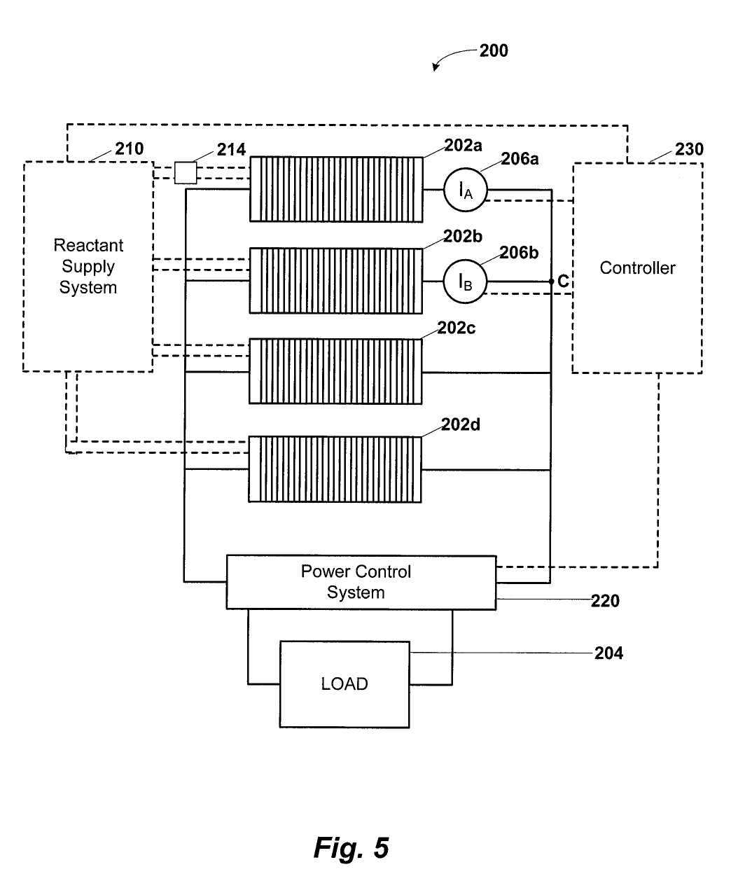

FIG. 5 shows another fuel cell system 200 including a plurality of fuel cell stacks 202a-d, electrically coupled in parallel to power load 204. Fuel cell system 200 includes a reactant supply system 210 and a power control system 220. Fuel cell system 200 also includes current sensors 206a-d so that the currents through at least two fuel cell stacks can be determined. Fuel cell system 200 also includes a controller 230 which is at least communicatively coupled to current sensors 206a-206d to receive current information.

Reactants, typically hydrogen gas and oxygen or air, are supplied from reactant supply system 200 to fuel cell stacks 202a-202d where the electrochemical reactions set out in Equations (1) and (2) take place to produce electrical power. The electrical power is transmitted to the power control system, where it is further transmitted to load 204. Current sensor 206a senses current i_{A} in fuel cell stack 202a. Current sensor 206b senses current i_{B} in fuel cell stack 206b. Information indicative of the currents i_{A}, i_{B} is transmitted to controller 230 which determines whether the current differential between the currents i_{A}, i_{B} exceeds a threshold, which is indicative of a fault, such as a cell reversal. If the threshold is exceeded, a fault response is triggered.

Reactant supply system 210 may include one or more reactant supply reservoirs or sources, a reformer, one or more compressor, pump, or reactant humidifier (not shown). Reactant supply system 210 may also include one or more valves, such as valve 214 for regulating flow of fuel to the fuel cell stacks 202a-202d. Reactant supply system 210 may include other reactant regulating elements such as switches, solenoids, and relays, for example. In some embodiments of fuel cell system 200, oxidant however may be consumed by the fuel cell directly from the ambient surroundings. A person of ordinary skill in the art may select an appropriate reactant supply system for a particular application.

Power control system 220 may control, condition, modify, rectify or invert power output from fuel cell stacks 202a-202d to supply power to load 204 and/or to controller 230 or reactant supply system 210 or other balance of plant elements, for example. Power control system 220 may include such elements as a DC/DC converter, DC/AC converter, or switches such as a transistor, relay, for example. However, in some embodiments fuel cell system 200 may not include a power control system and fuel cell stacks 202a-202d may provide power directly to load 204. A person of ordinary skill in the art may select an appropriate power control system, if any, for a particular application.

Controller 230 may be comprised of a programmable logic controller, logic gates, transistors, integrated circuits, switches relays, vacuum tubes or personal computer or may be a human attendant. A person of ordinary skill in the art may select an appropriate form of controller for a particular application. A suitable programmable logic controller, for example, is an Easy 820-DC-RC available from Moeller Electric Corporation of Wood Dale Ill., U.S.A.

Current sensors may be of a shunt or Hall effect variety, for example. Temperature sensors may include thermocouples, for example. A person of ordinary skill in the art may select an appropriate current and/or temperature sensor for a particular application.

Current differential may be determined on an instantaneous basis or may be determined based on a running average of current values, for example. Also, current threshold may be fixed or may be a function of a fuel cell system operating parameter which may be continuous or stored in a look up table. A person of ordinary skill in the art may select an appropriate method for determining current differential for a particular application.

A person of ordinary skill in the art will recognize that not all fuel cell stacks require an associated current sensing element in order to determine the current through all of the fuel cell stacks. For example, where three fuel cell stacks are electrically coupled in parallel, the first fuel cell stack may have its current sensed and the second stack may have its current sensed whereas the third stack may not directly have its current sensed. In such an example, the current from the third stack may be determined by sensing the total current and subtracting the current from the first and second fuel cell stacks.

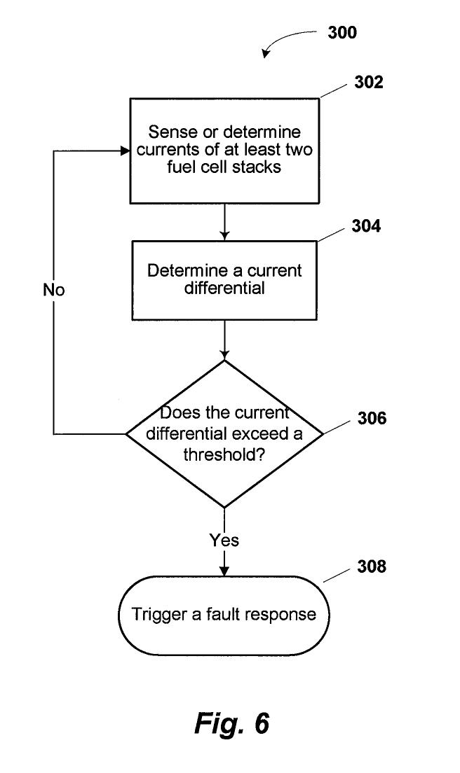

FIG. 6 shows an embodiment of a method for operating a fuel cell system comprising at least two fuel cell stacks electrically coupled in parallel. At 302 current is sensed in a first and second fuel cell stack. At 304, a current differential is determined. At 306 the current differential is compared to a threshold. If the current differential exceeds the threshold, a fault response is triggered, at 308. If the current differential does not exceed the threshold 302 is repeated. While represented stepwise, a person of ordinary skill in the art will recognize that the above could be conducted continuously and/or concurrently.

As noted fault responses include triggering an alarm, alerting an operator, electrically isolating all or part of the fuel cell stack or system, shutting down all or part of the system, and increasing the supply of reactant to the affected fuel cell stack. Increasing the supply of reactant has been shown to be effective in resuscitating a fuel cell stack, as disclosed in U.S. Pat. No. 6,861,167. Where a faulty fuel cell stack has been electrically isolated, a replacement or redundant fuel cell stack may be electrically coupled in its place after which the electrical connection may be reinstated.

Shutdown of the fuel cell and/or system may take place by any number of methods. For example, a person of ordinary skill in the art may select to open the whole electrical circuit or open particular branch of the fuel cell stacks electrically coupled in parallel where a fault has occurred. This may occur automatically via a relay, logic gate, transistor, microprocessor or computer. In another embodiment, an alarm may be provide via a sound and/or a light which may flash alerting an operator to manually take action. A person of ordinary skill in the art may select an appropriate method of implementing a fault response for a particular application.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to fuel cell systems, not necessarily the exemplary PEM fuel cell systems generally described above.

The various embodiments described above can be combined to provide further embodiments. To the extent that they are not inconsistent with the specific teachings and definitions herein, all of the above U.S. patents, U.S. patent application publications, U.S. patent applications, foreign patents, foreign patent applications and non-patent publications referred to in this specification and/or listed in the Application Data Sheet are incorporated herein by reference, in their entirety.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A method for operating a fuel cell system the fuel cell system having a first fuel cell stack operable to produce a first current, and at least a second fuel cell stack operable to produce a second current, the second fuel cell stack electrically coupled in parallel with the first fuel cell stack, the method comprising:
determining if a differential between the first current and the second current exceeds a threshold; and
triggering a fault response in response to the differential between the first current and the second current exceeding the threshold.

2. The method of claim 1, further comprising:
interrupting a flow of electricity between the first fuel cell stack and a load as at least part of the fault response, where a magnitude of the first current is less than a magnitude of the second current.

3. The method of claim 1, further comprising:
increasing a supply of a reactant to the first fuel cell stack as at least part of the fault response where the first current is greater than the second current.

4. The method of claim 1, further comprising:
alerting an operator as at least part of the fault response.

5. The method of claim 1, further comprising:
sensing the first current and sensing the second current.

6. The method of claim 1, further comprising:
determining a magnitude of the threshold based at least in part on at least some operating conditions of the fuel cell system.

7. The method of claim 1 wherein the fuel cell system has a third current which is at least the aggregation of the first current and the second current; and further comprising:
sensing the first current; and
calculating the second current based at least in part on the sensed first current.

8. The method of claim 1, further comprising:
sensing the first current with a Hall Effect sensor.

9. The method of claim 1, further comprising:
determining the differential between the first current and the second current via a controller.

10. A method for operating a fuel cell system, the fuel cell system having a first fuel cell stack operable to produces a first current, and at least a second fuel cell stack operable to produce a second current, the second fuel cell stack electrically coupled in parallel with the first fuel cell stack, the method comprising:
sensing the first current;
determining the second current;
determining a current differential between the first current and the second current; and
triggering a fault response when the current differential exceeds a threshold.

11. The method of claim 10 wherein determining the second current comprises sensing the second current.

12. The method of claim 11, further comprising:
interrupting a flow of electricity between the first fuel cell stack and a load as at least part of the fault response where a magnitude of the first current is less than a magnitude of the second current.

13. The method of claim 11, further comprising:
increasing a supply of a reactant to the first fuel cell stack as at least part of the fault response where a magnitude of the first current is less than a magnitude of the second current.

14. The method of claim 11, further comprising:
alerting an operator as at least part of the fault response.

15. The method of claim 11 wherein a magnitude of the threshold is based on at least one operating condition of the fuel cell system.

16. A method for operating a fuel cell system the fuel cell system having a first fuel cell stack characterized by a first temperature which can vary from time-to-time during operation, and at least a second fuel cell stack characterized by a second temperature which can vary from time-to-time during operation, the second fuel cell stack electrically coupled in parallel with the first fuel cell stack, the method comprising:
sensing the first temperature;
sensing the second temperature; and
triggering a fault response when a differential between the first temperature and the second temperature exceeds a threshold.

17. The method of claim 16, further comprising:
interrupting a flow of electricity between the first fuel cell stack and a load as at least part of the fault response where the first temperature is greater than the second temperature.

18. The method of claim 16, further comprising:
increasing a supply of a reactant to the first fuel cell stack as at least part of the fault response where the first temperature is greater than the second temperature.

19. The method of claim 16, further comprising:
alerting an operator as at least part of the fault response.

20. The method of claim 16 wherein a magnitude of the threshold is based on at least one operating condition of the fuel cell system.

21. The method of claim 16 wherein sensing the first temperature includes directly sensing a temperature of a physical portion of the first fuel cell stack.

22. The method of claim 16 wherein sensing the first temperature includes sensing a temperature of an ambient environment proximate the first fuel cell stack.

23. The method of claim 16 wherein sensing the first temperature includes sensing a temperature of the reaction product of the first fuel cell stack.
